(19) United States
(12) Patent Application Publication
(10) Pub. No.: US 2026/0359705 A1
(43) Pub. Date: Nov. 12, 2026

(54) INFORMATION PROCESSING SYSTEM, INFORMATION PROCESSING METHOD, AND NON-TRANSITORY RECORDING MEDIUM

(71) Applicant: NEC Corporation, Tokyo (JP)

(72) Inventor: Masahiro TAKAHASHI, Tokyo (JP)

(73) Assignee: NEC Corporation, Tokyo (JP)

(21) Appl. No.: 19/134,794

(22) PCT Filed: Dec. 9, 2022
(86) PCT No.: PCT/JP2022/045468

§ 371 Date: Jun. 2, 2025

(51) Int. Cl. G06N 20/00; G06V 40/16

(52) U.S. Cl. CPC G06N 20/00; G06V 40/172

(57) ABSTRACT

An information processing system includes: an input unit that inputs a first dataset and a second dataset into a learning model; an extraction unit that extracts an output of intermediate processing of the learning model; and an output unit that outputs a comparison result of the first dataset and the second dataset, in a space in which dimensions of the output of the intermediate processing are compressed. According to this information processing system, it is possible to efficiently collect data effective for machine learning, by using the comparison result of the datasets.

### TECHNICAL FIELD

The present disclosure relates to technical fields of an information processing system, an information processing method, and a recording medium.

### BACKGROUND ART

A known system of this type collects learning data and performs leaning of a machine learning model. Patent Literature 1 discloses a technique/technology for acquiring data on microscopic observation images of tissue samples and learning a model that determines a tissue type. Patent Literature 2 discloses a technique/technology for inputting a feature vector obtained from a neural network model into a classifier and determining a weight of the classifier, based on a result of comparing an output result of the classifier with comparison data. Patent Literature 3 discloses a technique/technology for acquiring images for learning to perform learning of a neural network and building a neural network that outputs feature quantities that allow restoration of the images for learning.

### CITATION LIST

### Patent Literature

Patent Literature 1: International Publication No. WO2021/132633

Patent Literature 2: International Publication No. WO2021/019748

Patent Literature 3: JP2019-215698A

### SUMMARY

### Technical Problem

The present disclosure aims to improve the techniques/technologies disclosed in Citation List.

### Solution to Problem

An information processing system according to an example aspect of the present disclosure includes: an input unit that inputs a first dataset and a second dataset into a learning model; an extraction unit that extracts an output of intermediate processing of the learning model; and an output unit that outputs a comparison result of the first dataset and the second dataset, in a space in which dimensions of the output of the intermediate processing are compressed.

An information processing method according to an example aspect of the present disclosure is an information processing method that is executed by at least one computer, the information processing method including: inputting a first dataset and a second dataset into a learning model; extracting an output of intermediate processing of the learning model; and outputting a comparison result of the first dataset and the second dataset, in a space in which dimensions of the output of the intermediate processing are compressed.

A recording medium according to an example aspect of the present disclosure is a recording medium on which a computer program that allows at least one computer to execute an information processing method is recorded, the information processing method including: inputting a first dataset and a second dataset into a learning model; extracting an output of intermediate processing of the learning model; and outputting a comparison result of the first dataset and the second dataset, in a space in which dimensions of the output of the intermediate processing are compressed.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a conceptual diagram illustrating a first dataset and a second dataset in an information processing system according to a second example embodiment.

FIG. 5 is a flowchart illustrating a flow of operation of an information processing system according to a fourth example embodiment.

FIG. 6 is a flowchart illustrating a flow of operation of an information processing system according to a fifth example embodiment.

FIG. 7 is a block diagram illustrating a functional configuration of an information processing system according to a sixth example embodiment.

FIG. 8 is a flowchart illustrating a flow of an update setting operation in the information processing system according to the sixth example embodiment.

FIG. 9 is a flowchart illustrating a flow of the update setting operation in an information processing system according to a seventh example embodiment.

FIG. 10 is a block diagram illustrating a functional configuration of an information processing system according to an eighth example embodiment.

FIG. 11 is a conceptual diagram illustrating an example of an image display operation by the information processing system according to the eighth example embodiment.

FIG. 12 is a block diagram illustrating a functional configuration of an information processing system according to a ninth example embodiment.

FIG. 13 is a conceptual diagram illustrating an example of a graph display operation by the information processing system according to the ninth example embodiment.

FIG. 14 is a block diagram illustrating a functional configuration of an information processing system according to a 10th example embodiment.

FIG. 15 is a flowchart illustrating a flow of operation of the information processing system according to the 10th example embodiment.

FIG. 16 is a conceptual diagram illustrating a comparison operation by an information processing system according to an 11th example embodiment.

FIG. 17 is a block diagram illustrating a functional configuration of an information processing system according to a 12th example embodiment.

FIG. 18 is a conceptual diagram illustrating a learning operation of the information processing system according to the 12th example embodiment.

FIG. 18 is a block diagram illustrating a functional configuration of an information processing system according to a 13th example embodiment.

FIG. 20 is a conceptual diagram illustrating an example of generating the first dataset in an information processing system according to a 14th example embodiment.

FIG. 21 is a conceptual diagram illustrating a comparison operation by an information processing system according to a 15th example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

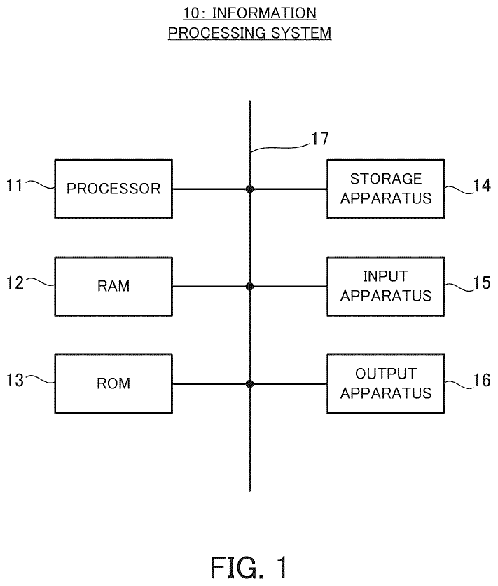

An information processing system according to a first example embodiment will be described with reference to FIG. 1 to FIG. 3.

### Hardware Configuration

First, with reference to FIG. 1, a hardware configuration of the information processing system according to the first example embodiment will be described. FIG. 1 is a block diagram illustrating the hardware configuration of the information processing system according to the first example embodiment.

As illustrated in FIG. 1, an information processing system 10 according to the first embodiment includes a processor 11, a RAM (Random Access Memory) 12, a ROM (Read Only Memory) 13, and a storage apparatus 14. The information processing system 10 may also include an input apparatus 15 and an output apparatus 16. The processor 11, the RAM 12, the ROM 13, the storage apparatus 14, the input apparatus 15, and the output apparatus 16 are connected via a data bus 17.

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may also acquire (i.e., may read) a computer program from a not-illustrated apparatus disposed outside the information processing system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for outputting a comparison result of comparing datasets is realized in the processor 11. That is, the processor 11 may function as a controller for executing each control in the information processing system 10.

The processor 11 may be configured as, for example, a CPU (central processing unit), a GPU (graphics processing unit), a FPGA (field-programmable gate array), a DSP (Digital Signal Processor), an ASIC (Application Specific Integrated Circuit), and a quantum processor. The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may be used in place of the RAM 12.

The ROM 13 stores the computer program to be executed by the processor 11. The ROM 13 may also store fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the information processing system 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing system 10 to the outside. For example, the output apparatus 16 may be a display device (e.g., a display) that is configured to display the information about the information processing system 10. The output apparatus 16 may also be a speaker or the like that is configured to audio-output the information about the information processing system 10. The output apparatus 16 may be configured as a portable terminal such as a smartphone and a tablet. The output apparatus 16 may also be an apparatus that outputs information in a format other than an image. For example, the output apparatus 16 may be a speaker that audio-outputs the information about the information processing system 10.

Although FIG. 1 illustrates an example of the information processing system 10 including a plurality of apparatuses, all or a part of the functions of these apparatuses may be realized by a single apparatus (an information processing apparatus). In that case, the information processing apparatus may include, for example, only the processor 11, the RAM 12, and the ROM 13. The other components (i.e., the storage apparatus 14, the input apparatus 15, the output apparatus 16, and the camera 18) may be provided in an external apparatus connected to the information processing apparatus. In addition, in the information processing apparatus, a part of an arithmetic function may be realized by an external apparatus (e.g., an external server or cloud, etc.).

### Functional Configuration

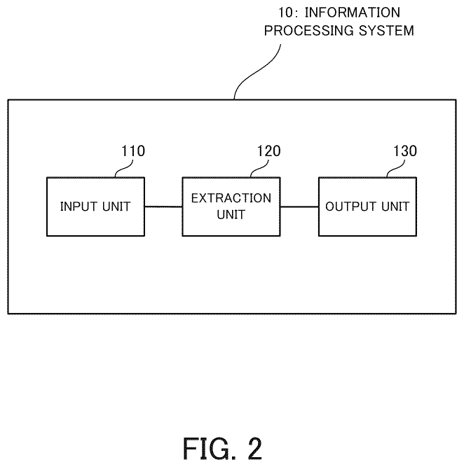

Next, with reference to FIG. 2, a functional configuration of the information processing system 10 according to the first example embodiment will be described. FIG. 2 is a block diagram illustrating the functional configuration of the information processing system according to the first example embodiment.

As illustrated in FIG. 2, the information processing system 10 according to the first example embodiment includes, as components for realizing the functions thereof, an input unit 110, an extraction unit 120, and an output unit 130. Each of the input unit 110, the extraction unit 120, and the output unit 130 may be a processing block realized by the processor 11 (see FIG. 1), for example.

The input unit 110 is configured to input a first dataset and a second dataset into a learning model. Here, each of the “first dataset” and the “second dataset” is a dataset including a plurality of pieces of data. The first dataset and the second dataset may, for example, include image data such as face images. Specific examples of the first dataset and the second dataset will be described in detail in another example embodiment later. The “learning model” is a model configured to enable machine learning by using a dataset that is training data, and may, for example, include a neural network. The learning model may be configured as a model for detecting an object from an image, for example. More specifically, the learning model may be configured as a model for detecting a face from a face image and detecting feature points of the face.

The extraction unit 120 is configured to extract an output of intermediate processing of the learning model into which the first dataset and the second dataset are inputted. The output of the intermediate processing may be, for example, an output of an intermediate layer among a plurality of layers provided in the learning model. The plurality of layers provided in the learning model may be an input layer, an intermediate layer, and an output layer, provided in a multilayer neural network. The input layer is a layer into which information is first inputted. The intermediate layer is a layer in which various calculations are performed on the information inputted into the input layer, and there may be provided a plurality of intermediate layers. The output layer is a layer in which calculation results in the intermediate layers are outputted. The output of the intermediate processing of the learning model is a result of various calculations performed on the inputted first dataset and the inputted second dataset, and may be, for example, multidimensional values indicating a relation between the first dataset and the second dataset. Hereinafter, the output of the intermediate processing of the learning model may be referred to as an “intermediate output” as appropriate. The intermediate output extracted by the extraction unit 120 is outputted to the output unit 130.

The output unit 130 is configured to compress dimensions of the intermediate output extracted by the extraction unit 120. Here, “compress the dimensions” refers to processing of reducing the dimensions of the intermediate output to a level that may be understood by humans. The output unit 130 may, for example, compress the dimensions of the intermediate output to two or three dimensions. The output unit 130 is further configured to output a comparison result of the first dataset and the second dataset, based on the intermediate output extracted by the extraction unit 120. The output unit 130 outputs the comparison result of the first dataset and the second dataset, in a space in which the dimensions are compressed. For example, when compressing the dimensions of the intermediate output to two dimensions, the output unit 130 may output the comparison result of the first dataset and the second dataset, as a two-dimensional map. Alternatively, when compressing the dimensions of the intermediate output to three dimensions, the output unit 130 may output the comparison result of the first dataset and the second dataset, as a three-dimensional map. The output unit 130 may output the comparison result of the first dataset and the second dataset, for example, by using the output apparatus 16 described above. More specifically, the output unit 130 may output the comparison result of the first dataset and the second dataset, by using a display provided in the output apparatus 16.

### Flow of Operation

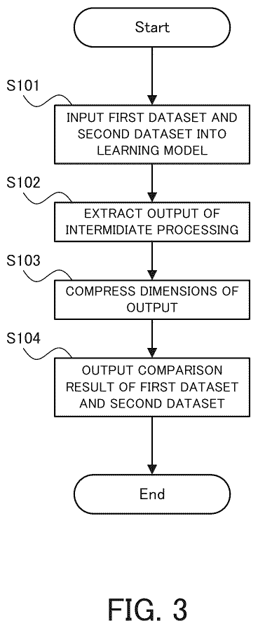

Next, with reference to FIG. 3, a flow of operation of the information processing system 10 according to the first example embodiment will be described. FIG. 3 is a flowchart illustrating the flow of the operation of the information processing system according to the first example embodiment.

As illustrated in FIG. 3, when the operation of the information processing system 10 according to the first example embodiment is started, first, the input unit 110 inputs the first dataset and the second dataset into the learning model (step S101). This starts processing in the learning model (i.e., processing that uses the first dataset and the second dataset as inputs).

Then, the extraction unit 120 extracts the output of the intermediate processing of the learning model (step S102). Then, the output unit 130 compresses the dimensions of the intermediate output extracted by the extraction unit 120 (step S103). After that, the output unit 130 outputs the comparison result of the first dataset and the second dataset, in the space in which the dimensions are compressed (step S104).

### Technical Effect

Next, a technical effect obtained by the information processing system 10 according to the first example embodiment will be described.

As described in FIG. 1 to FIG. 3, in the information processing system 10 according to the first example embodiment, the comparison result of the first dataset and the second dataset is outputted based on the output of the intermediate processing when the first dataset and the second dataset are inputted into the learning model. In this way, a difference between the first dataset and the second dataset may be easily grasped. Note that the output of the intermediate processing of the learning model is typically multidimensional values that are hard for humans to intuitively understand. In the present example embodiment, however, the comparison result is outputted in the space in which the dimensions are compressed. By this, a specific difference between data included in the first dataset and data included in the second dataset may be outputted in an aspect that is easy for humans to understand. A specific example of an output aspect will be described in another example embodiment later.

### Second Example Embodiment

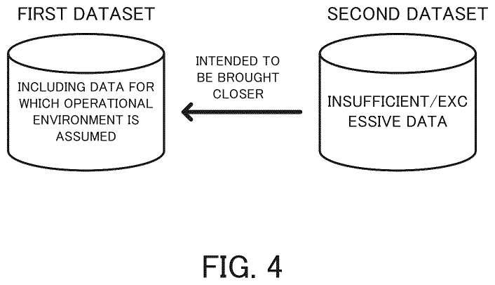

The information processing system 10 according to a second example embodiment will be described with reference to FIG. 4. The second example embodiment explains the specific examples of the first dataset and the second dataset described above, and may be the same as the first example embodiment in the other parts. For this reason, a part differing from the already described first example embodiment will be described in detail below, and a description of the other overlapping parts will be omitted as appropriate.

### Datasets

First, with reference to FIG. 4, the first dataset and the second dataset inputted to the information processing system 10 according to the second example embodiment will be specifically described. FIG. 4 is a conceptual diagram illustrating the first dataset and the second dataset in the information processing system according to the second example embodiment.

As illustrated in FIG. 4, the first dataset in the information processing system 10 according to the second example embodiment is a dataset serving as a target upon operating the learning model. Here, “upon operating” refers to processing performed upon operating the learning model that is subjected to machine learning in advance. For example, in a case where the learning model is used as a model for detecting a human face from image data, the first dataset may include face image data on various people.

On the other hand, the second dataset is a dataset intended to bring a data distribution closer to that of the first dataset serving as the target. The second dataset may be a dataset with insufficient data, for example, when compared with the first dataset. In this case, it is possible to bring the data distribution closer to that of the first dataset, by adding data corresponding to an insufficient part, to the second dataset. Alternatively, the second dataset may be a dataset with excessive data, when compared with the first dataset. In this case, it is possible to bring the data distribution closer to that of the first dataset, by removing data corresponding to an excessive part, from the second dataset.

A more specific example of the first dataset is a public dataset. For example, the first dataset may be an ideal dataset available on the Internet (i.e., a dataset including a sufficient amount and type of data, in an assumption of operating the learning model). On the other hand, a more specific example of the second dataset is an in-house dataset. For example, the second dataset may be an incomplete dataset collected by the user (i.e., a dataset in which data are insufficient or excessive, in an assumption of operating the learning model).

### Technical Effect

Next, a technical effect obtained by the information processing system 10 according to the second example embodiment will be described.

As described in FIG. 4, in the information processing system 10 according to the second example embodiment, the first dataset is a dataset serving as the target, and the second dataset is a dataset intended to be brought closer to the target. From the comparison result of the first dataset and the second dataset, it is possible to grasp data that are insufficient or excessive in the second dataset relative to the first dataset. Therefore, it is possible to specifically understand how to correct the second dataset to bring it closer to the first dataset.

### Third Example Embodiment

The information processing system 10 according to a third example embodiment will be described. The third example embodiment explains a specific example of a dimension compression method regarding the output of the intermediate processing, and may be the same as the first and second example embodiments in the other parts. For this reason, a part differing from each of the example embodiments described above will be described in detail below, and a description of the other overlapping parts will be omitted as appropriate.

### Dimension Compression Method

In the information processing system 10 according to the third example embodiment, the output unit 130 uses, as a method of compressing the dimensions of the intermediate output, at least one of PCA (Principal Component Analysis), t-SNE (t-Distributed Stochastic Neighbor Embedding), and UMAP (Uniform Manifold Approximation and Projection). That is, the output unit 130 may use any one of PCA, t-SNE, or UMAP to compress the dimensions, or may combine a plurality of methods from PCA, t-SNE, and UMAP to compress the dimensions. In addition to the above-mentioned PCA, t-SNE, and UMAP, the output unit 130 may also use another method to compress the dimensions.

### Technical Effect

Next, a technical effect obtained by the information processing system 10 according to the third example embodiment will be described.

In the information processing system 10 according to the third example embodiment, the dimensions of the output of the intermediate processing are compressed by using at least one of PCA, t-SNE, and UMAP. The use of these methods makes it possible to compress the dimensions, more properly.

### Fourth Example Embodiment

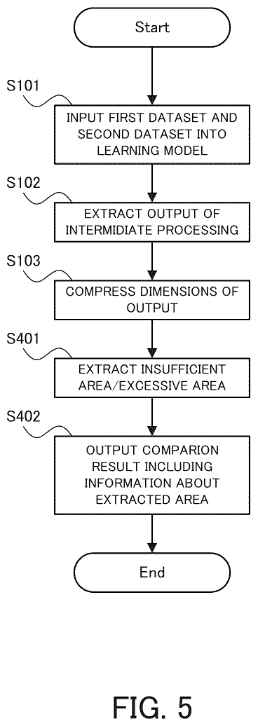

The information processing system 10 according to a fourth example embodiment will be described with reference to FIG. 5. The fourth example embodiment partially differs from the first to third example embodiments described above only in its operation, and may be the same as the first to third example embodiments in the other parts. For this reason, a part differing from each of the example embodiments described above will be described in detail below, and a description of the other overlapping parts will be omitted as appropriate.

### Flow of Operation

First, with reference to FIG. 5, a flow of operation of the information processing system 10 according to the fourth example embodiment will be described. FIG. 5 is a flowchart illustrating the flow of the operation of the information processing system according to the fourth example embodiment. In FIG. 5, the same steps as those described in FIG. 3 carry the same reference numerals.

As illustrated in FIG. 5, when the operation of the information processing system 10 according to the fourth example embodiment is started, first, the input unit 110 inputs the first dataset and the second dataset into the learning model (step S101). Then, the extraction unit 120 extracts the output of the intermediate processing of the learning model (step S102). After that, the output unit 130 compresses the dimensions of the intermediate output extracted by the extraction unit 120 (step S103).

Then, the output unit 130 compares the first dataset with the second dataset, and extracts at least one of an insufficient area and an excessive area from the comparison result (step S401). Here, the “insufficient area” is an area corresponding to an insufficient part of the second dataset relative to the first dataset. That is, the insufficient area is an area indicating the data that are insufficient in the second dataset. The “excessive area” is an area corresponding to an excessive part of the second dataset relative to the first dataset. That is, the excessive area is an area indicating the data that are excessive in the second dataset.

Then, the output unit 130 outputs the comparison result of the first dataset and the second dataset, as a result including information including the extracted at least one of the insufficient area and the excessive area (step S402). The output unit 130 outputs the insufficient area and the excessive area in the space in which the dimensions are compressed. For example, when outputting the comparison result of the first dataset and the second dataset as a two-dimensional map, the output unit 130 may output the insufficient area and the excessive area as two-dimensional areas. When outputting the comparison result of the first dataset and the second dataset as a three-dimensional map, the output unit 130 may output the insufficient area and the excessive area as three-dimensional areas.

### Technical Effect

Next, a technical effect obtained by the information processing system 10 according to the fourth example embodiment will be described.

As described in FIG. 5, in the information processing system 10 according to the fourth example embodiment, at least one of the insufficient area and the excessive area in the second dataset relative to the first dataset is outputted. In this way, it is possible to easily grasp the data that re insufficient or excessive in the second dataset.

### Fifth Example Embodiment

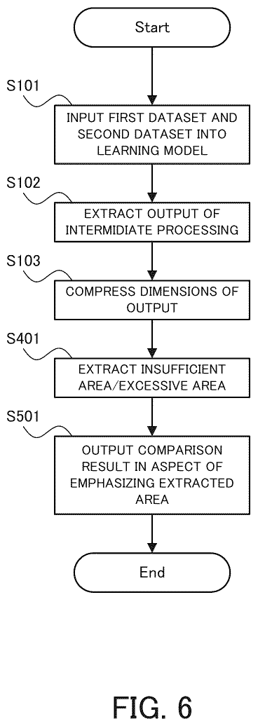

The information processing system 10 according to a fifth example embodiment will be described with reference to FIG. 6. The fifth example embodiment partially differs from the fourth example embodiment described above only in its operation, and may be the same as the first to fourth example embodiments in the other parts. For this reason, a part differing from each of the example embodiments described above will be described in detail below, and a description of the other overlapping parts will be omitted as appropriate.

### Flow of Operation

First, with reference to FIG. 6, a flow of operation of the information processing system 10 according to the fifth example embodiment will be described. FIG. 6 is a flowchart illustrating the flow of the operation of the information processing system according to the fifth example embodiment. In FIG. 6, the same steps as those illustrated in FIG. 5 carry the same reference numerals.

As illustrated in FIG. 6, when the operation of the information processing system 10 according to the fifth example embodiment is started, first, the input unit 110 inputs the first dataset and the second dataset into the learning model (step S101). Then, the extraction unit 120 extracts the output of the intermediate processing of the learning model (step S102). After that, the output unit 130 compresses the dimensions of the intermediate output extracted by the extraction unit 120 (step S103).

Then, the output unit 130 compares the first dataset with the second dataset, and extracts at least one of the insufficient area and the excessive area from the comparison result (step S401).

Then, the output unit 130 outputs the comparison result of the first dataset and the second dataset, as a result including information including the extracted at least one of the insufficient area and the excessive area. At that time, especially in the present example embodiment, the output unit 130 outputs the comparison result in an aspect of emphasizing the insufficient area and the excessive area. For example, the output unit 130 outputs the comparison result such that the insufficient area and the excessive area are more prominent than other parts in a map indicating the comparison result of the first dataset and the second dataset. More specifically, the output unit 130 may display the insufficient area and the excessive area in a different color from that of another area. Alternatively, the output unit 130 may display the insufficient area and the excessive area surrounded by a frame in a prominent color. Alternatively, the output unit 130 may flash and display the insufficient area and the excessive area.

The above-described aspects are merely examples, and the output unit 130 may emphasize the insufficient area and the excessive area in another aspect.

### Technical Effect

Next, a technical effect obtained by the information processing system 10 according to the fifth example embodiment will be described.

As described in FIG. 6, in the information processing system 10 according to the fifth example embodiment, at least one of the insufficient area and the excessive area in the second dataset relative to the first dataset is emphasized and outputted. In this way, it is possible to more easily grasp the data that are insufficient or excessive in the second dataset.

### Sixth Example Embodiment

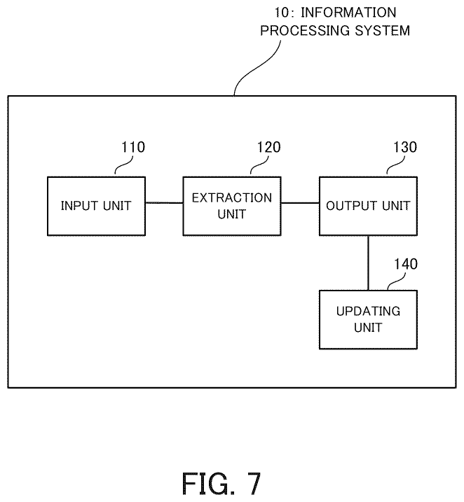

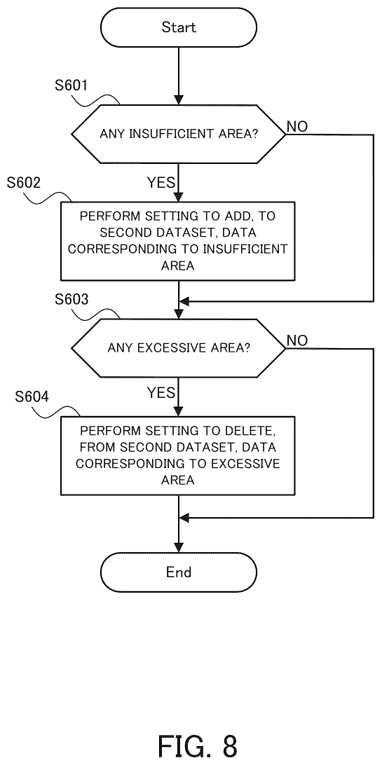

The information processing system 10 according to a sixth example embodiment will be described with reference to FIG. 7 and FIG. 8. The sixth example embodiment partially differs from the first to fifth example embodiments only in its configuration and operation, and may be the same as the first to fifth example embodiments in the other parts. For this reason, a part differing from each of the example embodiments described above will be described in detail below, and a description of the other overlapping parts will be omitted as appropriate.

### Functional Configuration

First, with reference to FIG. 7, a functional configuration of the information processing system 10 according to the sixth example embodiment will be described. FIG. 7 is a block diagram illustrating the functional configuration of the information processing system according to the sixth example embodiment. In FIG. 7, the same components as those illustrated in FIG. 2 carry the same reference numerals.

As illustrated in FIG. 7, the information processing system 10 according to the sixth example embodiment includes, as components for realizing the functions thereof, the input unit 110, the extraction unit 120, the output unit 130, and an updating unit 140. That is, the information processing system 10 according to the sixth example embodiment further includes the updating unit 140, in addition to the configuration in the first example embodiment (see FIG. 2). The updating unit 140 may be a processing block realized by the processor 11 (see FIG. 1), for example.

The updating unit 140 is configured to add data to the second dataset, based on the insufficient area outputted by the output unit 130. That is, the updating unit 140 is configured to add, to the second dataset, data corresponding to the insufficient part of the second dataset relative to the first dataset. Furthermore, the updating unit 140 is configured to delete data from the second dataset, based on the excessive area outputted by the output unit 130. That is, the updating unit 140 is configured to delete, from the second dataset, data corresponding to the excessive part of the second dataset relative to the first dataset.

### Update Setting Operation

Next, with reference to FIG. 8, an update setting operation (i.e., the operation of the updating unit 140 described above) will be described. FIG. 8 is a flowchart illustrating a flow of the update setting operation in the information processing system according to the sixth example embodiment.

As illustrated in FIG. 8, in the update setting operation by the information processing system 10 according to the sixth example embodiment, first, the updating unit 140 determines whether or not there is the insufficient area in the second dataset (step S601). That is, the updating unit 140 determines whether or not there are data that are insufficient in the second dataset, when compared with the first dataset.

Then, when there are the insufficient area (the step S601: YES), the updating unit 140 performs setting to add, to the second dataset, data corresponding to the insufficient area (step S602). In a case where the setting is performed to add the data to the second dataset and, for example, when new data are acquired, the updating unit 140 determines whether the acquired data include the data corresponding to the insufficient area. In a case where the acquired data include the data corresponding to the insufficient area, the data are added to the second dataset. When there are no insufficient area in the second dataset (the step S601: NO), the step S602 described above may be omitted.

Then, the updating unit 140 determines whether or not there is the excessive area in the second dataset (step S603). That is, the updating unit 140 determines whether or not there are data that are excessive in the second dataset, when compared with the first dataset.

Then, when there is the excessive area (the step S603: YES), the updating unit 140 performs setting to delete, from the second dataset, data corresponding to the excessive area (step S604). In a case where the setting is performed to delete the data from the second dataset, the updating unit 140 may immediately delete the data corresponding to the excessive area, or may delete the data at another time. For example, the updating unit 140 may confirm with the user whether it is acceptable to delete the data, and in a case where the user agrees to delete the data, the updating unit 140 may delete the data corresponding to the excessive area, from the second dataset. When there is no excessive area in the second dataset (the step S603: NO), the step S604 described above may be omitted.

Here, given is an example in which the updating unit 140 is configured to perform both data addition and data deletion, but the updating unit 140 may be configured to perform only one of data addition and data deletion. For example, in a case where the updating unit 140 performs only data addition, only the steps S601 and S602 described above may be performed. In a case where the updating unit 140 only data deletion, only the steps S603 and S604 described above may be performed.

### Technical Effect

Next, a technical effect obtained by the information processing system 10 according to the sixth example embodiment will be described.

As described in FIG. 7 and FIG. 8, in the information processing system 10 according to the sixth example embodiment, data are added to or deleted from the second dataset, based on the outputted insufficient area and the outputted excessive area. In this way, it is possible to efficiently bring the second dataset closer to the first dataset.

### Seventh Example Embodiment

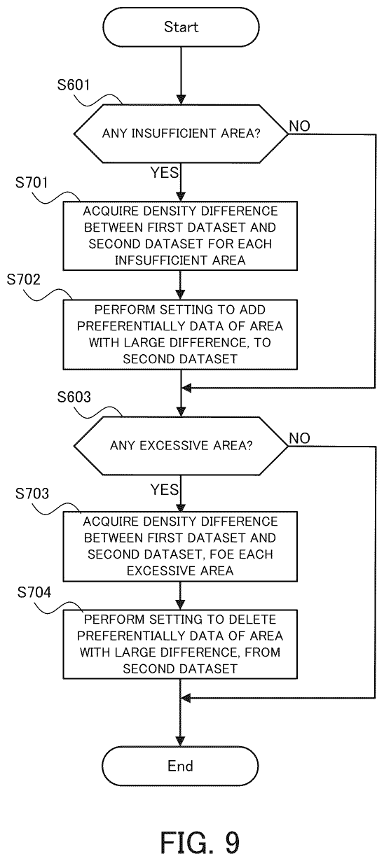

The information processing system 10 according to a seventh example embodiment will be described with reference to FIG. 9. The seventh example embodiment partially differs from the sixth example embodiment described above only in its operation, and may be the same as the first to sixth example embodiments in the other parts. For this reason, a part differing from each of the example embodiments described above will be described in detail below, and a description of the other overlapping parts will be omitted as appropriate.

### Update Setting Operation

First, with reference to FIG. 9, the update setting operation according to the seventh example embodiment will be described. FIG. 9 is a flowchart illustrating a flow of the update setting operation in the information processing system according to the seventh example embodiment. In FIG. 9, the same steps as those illustrated in FIG. 8 carry the same reference numerals.

As illustrated in FIG. 9, in the update setting operation by the information processing system 10 according to the seventh example embodiment, first, the updating unit 140 determines whether or not there is the insufficient area in the second dataset (step S601). When there is no insufficient area in the second dataset (the step S601: NO), the subsequent steps S701 and S702 may be omitted.

When there is the insufficient area in the second dataset (the step S601: YES), the updating unit 140 acquires a density difference between the first dataset and the second dataset, for each insufficient area (step S701). That is, the updating unit 140 acquires the density difference between the first dataset and the second dataset, for each of a plurality of insufficient areas in the second dataset (in other words, how much data are insufficient). In a case where there is only one insufficient area in the second dataset, the density difference may not be acquired. In this case, the updating unit 140 may perform setting to add, to the second dataset, the data corresponding to the insufficient area, as in the sixth example embodiment (see the step S602 in FIG. 8).

The density difference in the insufficient area may be acquired based on the comparison result of the first dataset and the second dataset. More specifically, the density difference may be a difference between the number of data points included in the first dataset and the number of data points included in the second dataset, in the insufficient area. In a case where there is a large difference between the total number of data points in the first dataset and the total number of data points in the second dataset, the difference may be calculated after performing normalization processing (i.e., after aligning the total number of data points).

After that, the updating unit 140 performs setting to add preferentially the data of an area with a larger density difference, among the plurality of insufficient areas (step S702). For example, the updating unit 140 sets a priority order based on the density difference, for each of the plurality of insufficient areas. Specifically, the updating unit 140 sets an area with the largest density difference as a first priority, sets an area with the second largest density difference as a second priority, and so on. In this case, the data are added preferentially to an area with higher priority (i.e., an area with a larger density difference).

Then, the updating unit 140 determines whether or not there is the excessive area in the second dataset (step S603). When there is no excessive area in the second dataset (the step S603: NO), the subsequent steps S703 and S704 may be omitted.

When there is the excessive areas in the second dataset (the step S603: YES), the updating unit 140 acquires a density difference between the first dataset and the second dataset, for each excessive area (step S703). That is, the updating unit 140 acquires the density difference between the first dataset and the second dataset, for each of a plurality of excessive areas in the second dataset. In a case where there is only one excessive area in the second dataset, the density difference may not be acquired. In this case, the updating unit 140 perform setting to delete, from the second dataset, the data corresponding to the excessive area, as in the sixth example embodiment (see step S604 in FIG. 8).

The density difference in the excessive area may be acquired based on the comparison result of the first dataset and the second dataset, as in the density difference in the insufficient area. More specifically, the density difference may be, for example, a difference between the number of data points included in the first dataset and the number of data points included in the second dataset, in the excessive area. In a case where there is a large difference between the total number of data points in the first dataset and the total number of data points in the second dataset, the difference may be calculated after performing normalization processing.

After that, the updating unit 140 performs setting to delete preferentially the data of an area with a larger density difference, among the plurality of excessive areas (step S704). For example, the updating unit 140 sets a priority order based on the density difference, for each of the plurality of excessive areas. Specifically, the updating unit 140 sets an area with the largest density difference as a first priority, sets an area with the second largest density difference as a second priority, and so on. In this case, the data are deleted preferentially from an area with higher priority (i.e., an area with a larger density difference).

### Technical Effect

Next, a technical effect obtained by the information processing system 10 according to the seventh example embodiment will be described.

As described in FIG. 9, in the information processing system 10 according to the seventh example embodiment, data are added to or deleted from the second dataset, based on the density difference between the first dataset and the second dataset. In this way, since correction is performed, starting from in a part with a larger difference, it is possible to more efficiently bring the second dataset closer to the first dataset.

### Eighth Example Embodiment

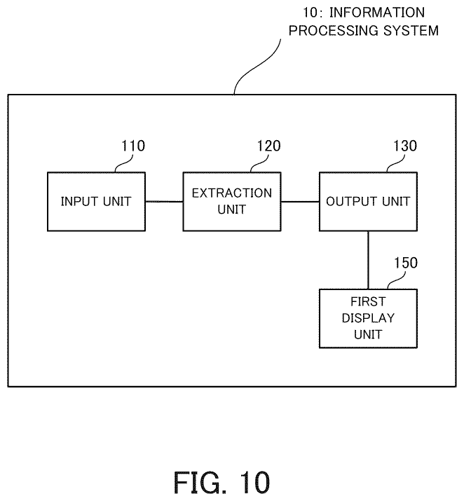

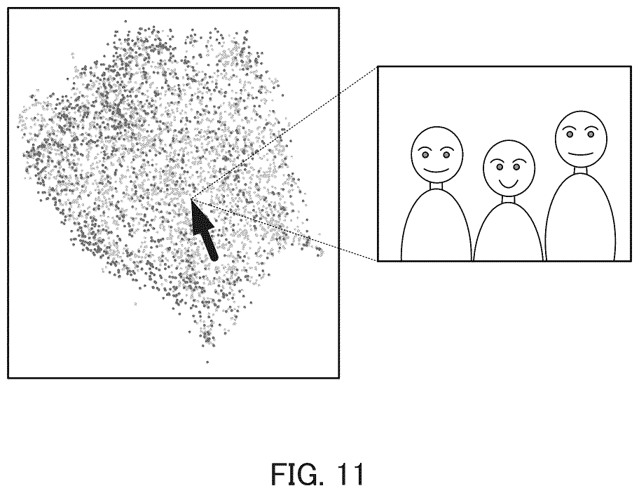

The information processing system 10 according to an eighth example embodiment will be described with reference to FIG. 10 and FIG. 11. The eighth example embodiment partially differs from the first to seventh example embodiments only in its configuration and operation, and may be the same as the first to seventh example embodiments in the other parts. For this reason, a part differing from each of the example embodiments described above will be described in detail below, and a description of the other overlapping parts will be omitted as appropriate.

### Functional Configuration

First, with reference to FIG. 10, a functional configuration of the information processing system 10 according to the eighth example embodiment will be described. FIG. 10 is a block diagram illustrating the functional configuration of the information processing system according to the eighth example embodiment. In FIG. 10, the same components as those illustrated in FIG. 2 carry the same reference numerals.

As illustrated in FIG. 10, the information processing system 10 according to the eighth example embodiment includes, as components for realizing the functions thereof, the input unit 110, the extraction unit 120, the output unit 130, and a first display unit 150. That is, the information processing system 10 according to the eighth example embodiment further includes the first display unit 150, in addition to the configuration in the first example embodiment (see FIG. 2). The first display unit 150 may be a display provided in the output apparatus 16 (see FIG. 1), for example.

The first display unit 150 is configured to display the comparison result of the first dataset and the second dataset, as a plurality of objects. For example, the first display unit 150 is configured to display each of the plurality of pieces of data included in the first dataset and the second dataset, as the plurality of objects on a two-dimensional map. Each of the plurality of objects displayed on the first display unit 150 is selectable by the user. For example, when the user performs an operation of clicking an object, the clicked object may be treated as a selected object. Furthermore, the first display unit 150 is configured to display the content of data corresponding to the selected object. For example, in a case where the first dataset and the second dataset include image data, the first display unit 150 may display an image corresponding to the selected object.

### Image Display Operation

Next, with reference to FIG. 11, an image display operation (i.e., the operation of the first display unit 150) by the information processing system 10 according to the eighth example embodiment will be described. FIG. 11 is a conceptual diagram illustrating an example of the image display operation by the information processing system according to the eighth example embodiment.

In the example in FIG. 11, the first display unit 150 displays the comparison result of the first dataset and the second dataset, as a two-dimensional map. Each of a plurality of points (objects) displayed on the two-dimensional map corresponds to respective one of the pieces of data included in each dataset. Specifically, light-color points in FIG. 11 indicate the data included in the first dataset, and dark points indicate the data included in the second dataset.

The plurality of points displayed by the first display unit 150 are selectable by the user. When the user selects one point, the content of data corresponding to the selected point is displayed. FIG. 11 indicates an example in which an image corresponding to the selected object is displayed. The plurality of objects may be simultaneously selectable. In this case, a plurality of images corresponding to the selected plurality of points may be displayed side by side.

Given here is an example in which the first dataset and the second dataset include image data, but the first dataset and the second dataset may include data other than a set of the image data. For example, in a case where the first dataset and the second dataset include text data, text corresponding to the selected object may be displayed.

### Technical Effect

Next, a technical effect obtained by the information processing system 10 according to the eighth example embodiment will be described.

As described in FIG. 10 and FIG. 11, in the information processing system 10 according to the eighth example embodiment, the content of the data corresponding to the selected object is displayed. In this way, it is possible to display the comparison result of the first and second datasets as the plurality of objects and to confirm what type of data each object corresponds to. Thus, it is possible to confirm what type of data are insufficient or excessive in the second dataset.

### Ninth Example Embodiment

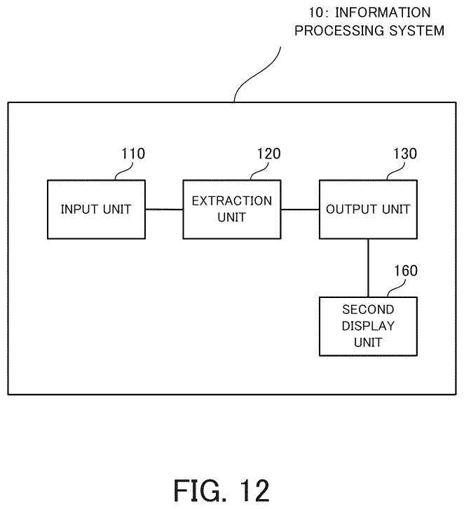

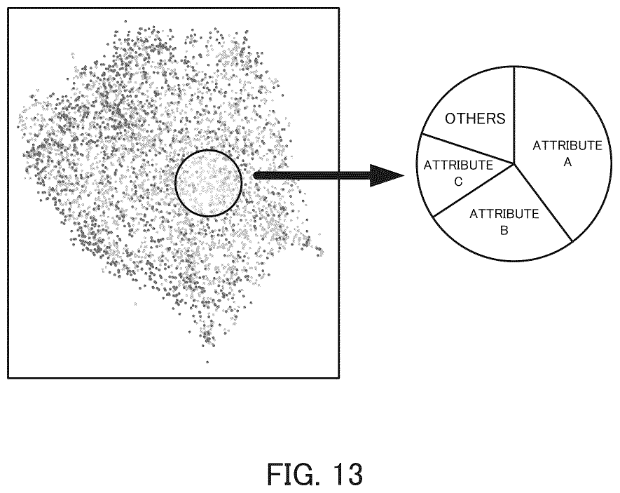

The information processing system 10 according to a ninth example embodiment will be described with reference to FIG. 12 and FIG. 13. The ninth example embodiment partially differs from the first to eighth example embodiments only in its configuration and operation, and may be the same as the first to eighth example embodiments in the other parts. For this reason, a part differing from each of the example embodiments described above will be described in detail below, and a description of the other overlapping parts will be omitted as appropriate.

### Functional Configuration

First, with reference to FIG. 12, a functional configuration of the information processing system 10 according to the ninth example embodiment will be described. FIG. 12 is a block diagram illustrating the functional configuration of the information processing system according to the ninth example embodiment. In FIG. 12, the same components as those illustrated in FIG. 2 carry the same reference numerals.

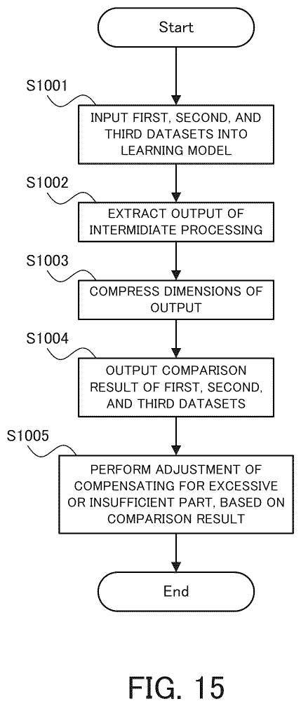

As illustrated in FIG. 15, the information processing system 10 according to the ninth example embodiment includes, as components for realizing the functions thereof, the input unit 110, the extraction unit 120, the output unit 130, and a second display unit 160. That is, the information processing system 10 according to the ninth example embodiment further includes the second display unit 160, in addition to the configuration in the first example embodiment (see FIG. 2). The second display unit 160 may be a display provided in the output apparatus 16 (see FIG. 1), for example.

The second display unit 160 is configured to display the comparison result of the first dataset and the second dataset, in an aspect that allows area selection. Here, “area selection” means selecting a desired area from the comparison result of the first dataset and the second dataset. For example, in a case where the comparison result of the first dataset and the second dataset is outputted as a two-dimensional map, an area designated by the user's operation may be treated as a selected area. More specifically, when the user performs an operation of clicking a plurality of parts on the two-dimensional map, an area enclosed by a frame connecting the clicked parts may

The second display unit 160 is configured to graphically display a ratio of data included in the selected area, by attribute. For example, in a case where the first dataset and the second dataset include image data, the second display unit 160 graphically displays the ratio of a plurality of pieces of image data included in the selected area, by image attribute. The image attribute may be determined by an object included in an image. Specifically, the image attribute may be an attribute indicating an image including many human faces, an attribute indicating an image including many animals, or an attribute indicating an image including many buildings. Alternatively, the image attribute may indicate a direction of a human face included in the image. For example, the image attribute may be an attribute indicating an image including a face facing right, an attribute indicating an image including a face facing left, or an attribute indicating an image including a face facing forward.

The second display unit 160 may be configured to have the function of the first display unit 150 in the eighth example embodiment described above. That is, the second display unit 160 may have a function of displaying the content of the selected object, in addition to a function of graphically displaying the ratio of data included in the selected area.

### Graph Display Operation

Next, with reference to FIG. 13, a graph display operation (i.e., the operation of the second display unit 160) by the information processing system 10 according to the ninth example embodiment will be described. FIG. 13 is a conceptual diagram illustrating an example of the graph display operation by the information processing system according to the ninth example embodiment.

In the example of FIG. 13, the second display unit 160 displays the comparison result of the first dataset and the second dataset, as a two-dimensional map. As in the eighth example embodiment described above, each of the plurality of points displayed on the two-dimensional map corresponds to respective one of the pieces of data included in each dataset. Specifically, light-color points in FIG. 13 indicate the data included in the first dataset, and dark points indicate the data included in the second dataset.

The two-dimensional map displayed by the second display unit 160 allows area selection by the user. When the user selects an area, the ratio of data included in the selected area (an area enclosed by a circle in the figure) is graphically displayed, by attribute. In the example in FIG. 13, the ratio of data included in the area is displayed as a pie chart. The second display unit 160 may use a graph other than the pie chart to display the ratio of data, by attribute. Alternatively, the second display unit 160 may display the ratio of data in numerical manner. For example, the second display unit 160 may display a score corresponding to the ratio of data, by attribute.

### Technical Effect

Next, a technical effect obtained by the information processing system 10 according to the ninth example embodiment will be described.

As described in FIG. 12 and FIG. 13, in the information processing system 10 according to the ninth example embodiment, the ratio of data included in the selected area is graphically displayed, by attribute. In this way, it is possible to easily grasp which attribute of data are included in the selected area. Therefore, it is possible to confirm which attribute of data are insufficient or excessive in the second dataset.

### 10th Example Embodiment

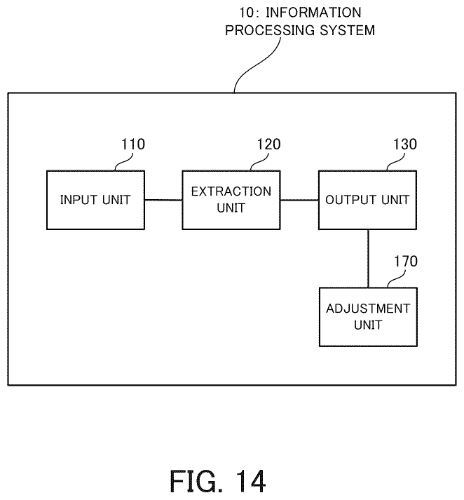

The information processing system 10 according to a 10th example embodiment will be described with reference to FIG. 14 and FIG. 15. The 10th example embodiment partially differs from the first to the ninth example embodiments only in its configuration and operation, and may be the same as the first to the ninth example embodiments in the other parts. For this reason, a part differing from each of the example embodiments described above will be described in detail below, and a description of the other overlapping parts will be omitted as appropriate.

### Functional Configuration

First, with reference to FIG. 14, a functional configuration of the information processing system 10 according to the 10th example embodiment will be described. FIG. 14 is a block diagram illustrating the functional configuration of the information processing system according to the 10th example embodiment. In FIG. 14, the same components as those illustrated in FIG. 2 carry the same reference numerals.

As illustrated in FIG. 14, the information processing system 10 according to the 10th example embodiment includes, as components for realizing the functions thereof, the input unit 110, the extraction unit 120, the output unit 130, and an adjustment unit 170. That is, the information processing system 10 according to the 10th example embodiment further includes the adjustment unit 170, in addition to the configuration in the first example embodiment (see FIG. 2). The adjustment unit 170 may be a processing block realized by the processor 11 (see FIG. 1), for example.

The input unit 110 according to the 10th example embodiment is configured to input a third dataset, in addition to the first dataset and the second dataset. The output unit 130 is configured to output a comparison result of the first dataset, the second dataset, and the third dataset.

The adjustment unit 170 is configured to perform adjustment of compensating for the excessive or insufficient part of each dataset, based on the comparison result of the first dataset, the second dataset, and the third dataset. That is, the adjustment unit 170 may perform processing of adding data corresponding to the insufficient part to a dataset with insufficient data, and may perform processing of deleting data corresponding to the excessive part from a dataset with excessive data, among the first dataset, the second dataset, and the third dataset. Alternatively, the adjustment unit 170 may perform processing of moving data among the datasets. For example, the adjustment unit 170 may perform processing of moving data included in the first dataset to the second dataset or the third dataset.

As described in the second example embodiment, in a case of setting the dataset serving as the target, for example, the first dataset may be set as the target, and the second and third datasets may be set as datasets intended to be brought closer to the target. That is, a plurality of datasets intended to be brought closer to the target may be set. Alternatively, the first and second datasets may be set as the target, and the third dataset may be set as a dataset intended to be brought closer to the target. That is, a plurality of datasets may be set as the target.

### Flow of Operation

Next, with reference to FIG. 15, a flow of operation of the information processing system 10 according to the 10th example embodiment will be described. FIG. 15 is a flowchart illustrating the flow of the operation of the information processing system according to the 10th example embodiment.

As illustrated in FIG. 15, when the operation of the information processing system 10 according to the 10th example embodiment is started, first, the input unit 110 inputs the first dataset, the second dataset, and the third dataset into the learning model (step S1001). After that, the extraction unit 120 extracts the output of the intermediate processing of the learning model (step S1002).

Then, the output unit 130 compresses the dimensions of the intermediate output extracted by the extraction unit 120 (step S1003). Then, the output unit 130 outputs the comparison result of the first, second, and third datasets, in the space in which the dimensions are compressed (step S1004).

Then, the adjustment unit 170 performs adjustment of compensating for the excessive or insufficient part of each dataset, based on the comparison result of the first to third datasets (step S1005). The adjustment by the adjustment unit 170 may be performed at a time when new data are acquired. That is, when new data are acquired, the adjustment unit 170 may perform processing of extracting data that are insufficient in each dataset from the acquired data and of adding the extracted data to each dataset.

### Technical Effect

Next, a technical effect obtained by the information processing system 10 according to the 10th example embodiment will be described.

As described in FIG. 14 and FIG. 15, in the information processing system 10 according to the 10th example embodiment, adjustment is performed to compensate for the excessive or insufficient part of each dataset, based on the comparison result of the first dataset, the second dataset, and the third dataset. In this way, it is possible to adjust each of three or more datasets into a more appropriate state. Given in the present example embodiment is an example in which three datasets (i.e., the first dataset, the second dataset, and the third dataset) are inputted into the learning model, but four or more datasets may be inputted. In this case, adjustment may be performed to compensate for the excessive or insufficient part of each dataset, based on the comparison result of the inputted four or more datasets.

### 11th Example Embodiment

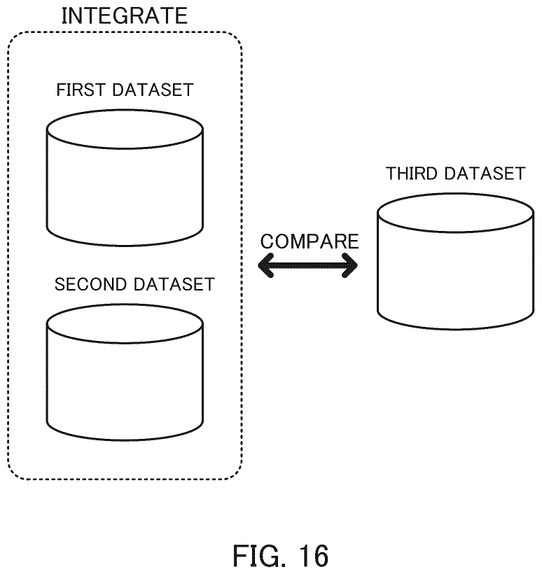

The information processing system 10 according to an 11th example embodiment will be described with reference to FIG. 16. The 11th example embodiment partially differs from the 10th example embodiment described above only in its operation, and may be the same as those in the first to 10th example embodiments in the other parts. For this reason, a part differing from each of the example embodiments described above will be described in detail below, and a description of the other overlapping parts will be omitted as appropriate.

### Dataset Integration

First, with reference to FIG. 16, a dataset comparison operation by the information processing system 10 according to the 11th example embodiment will be described. FIG. 16 is a conceptual diagram illustrating the comparison operation by the information processing system according to the 11th example embodiment.

As illustrated in FIG. 16, first, the output unit 130 of the information processing system 10 according to the 11th example embodiment performs processing of integrating the first dataset and the second dataset (hereinafter referred to as “integration processing” as appropriate). For example, the integration processing may be simply adding the data included in the first dataset and the data included in the second dataset. Alternatively, the integration processing may be processing of averaging the data included in the first dataset and the data included in the second dataset. Alternatively, the integration processing may be processing of normalizing the first dataset and the second dataset by density comparison, and then adding the data included in the first dataset and the data included in the second dataset.

After performing the integration processing, the output unit 130 outputs a result of comparison between the third dataset and an integration result of the first and second datasets. That is, the output unit 130 outputs a result of comparison between one dataset and an integration result of two datasets. In a case where there are four or more datasets, the output unit 130 may output a comparison result of the integration results. For example, the output unit 130 may output a result of comparison between the integration result of the first and second datasets and the integration result of the third and fourth datasets.

### Technical Effect

Next, a technical effect obtained by the information processing system 10 according to the first example embodiment will be described.

As described in FIG. 16, in the information processing system 10 according to the 11th example embodiment, the result of integrating the first dataset and the second dataset are compared with the third dataset. In this way, it is possible to efficiently compare three or more datasets. For example, it is possible to output a result of comparison between the first and second dataset serving as the target and the third dataset intended to be brought closer to the target.

### 12th Example Embodiment

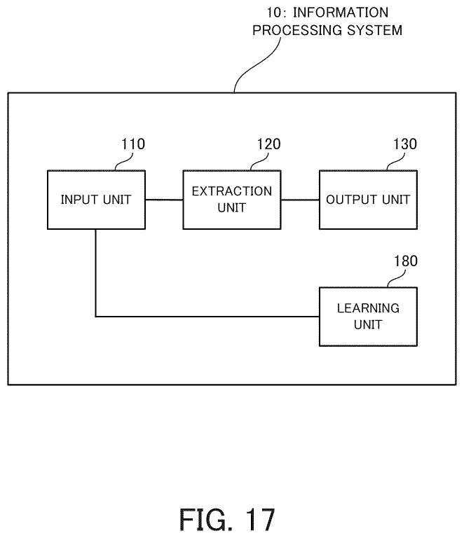

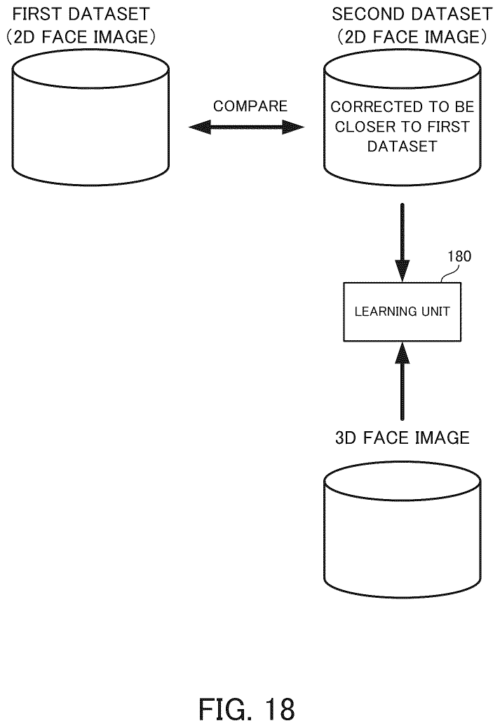

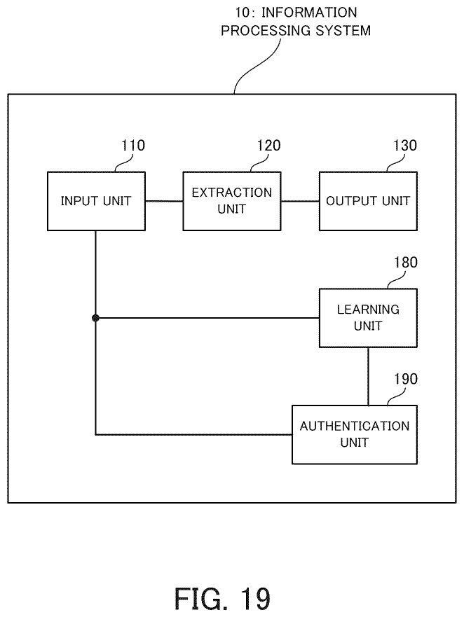

The information processing system 10 according to a 12th example embodiment will be described with reference to FIG. 17 and FIG. 18. The 12th example embodiment partially differs from the first to 11th example embodiments only in its configuration and operation, and may be the same as the first to 11th example embodiments in the other parts. For this reason, a part differing from each of the example embodiments described above will be described in detail below, and a description of the other overlapping parts will be omitted as appropriate.

### Functional Configuration

First, with reference to FIG. 17, a functional configuration of the information processing system 10 according to the 12th example embodiment will be described. FIG. 17 is a block diagram illustrating the functional configuration of the information processing system according to the 12th example embodiment. In FIG. 17, the same components as those illustrated in FIG. 2 carry the same reference numerals.

As illustrated in FIG. 17, the information processing system 10 according to the 12th example embodiment includes, as components for realizing the functions thereof, the input unit 110, the extraction unit 120, the output unit 130, and a learning unit 180. That is, the information processing system 10 according to the 12th example embodiment further includes the learning unit 180, in addition to the configuration in the first example embodiment (see FIG. 2). The learning unit 180 may be a processing block realized by the processor 11 (see FIG. 1), for example.

Each of the first dataset and the second dataset according to the 12th example embodiment includes a 2D face image (i.e., a two-dimensional face image). The second dataset is corrected to be closer to the first dataset, based on the comparison result outputted by the output unit 130. That is, data are added to or deleted from the second dataset, with the first dataset as the target. Such correction processing may be performed by the updating unit 140 (see FIG. 7), for example.

The learning unit 180 is configured to perform learning of a face authentication engine used for face authentication, by using the second dataset corrected as described above. More specifically, the learning unit 180 is configured to perform the learning of the face authentication engine, by using a plurality of 2D face images included in the corrected second dataset and a 3D face image (i.e., a three-dimensional face image) of a person corresponding to the plurality of 2D face images. The face authentication engine learned/trained by the learning unit 180 may be an engine that is configured to perform the face authentication by using the 2D face images and the 3D face image. For example, the face authentication engine may be an engine that performs the face authentication by collating/verifying the 2D face images and the 3D face image.

### Learning Operation

Next, with reference to FIG. 18, a learning operation (i.e., the operation of the learning unit 180) by the information processing system 10 according to the 12th example embodiment will be described. FIG. 18 is a conceptual diagram illustrating the learning operation by the information processing system according to the 12th example embodiment.

As illustrated in FIG. 18, in the information processing system 10 according to the 12th example embodiment, first, the second dataset is corrected to be closer to the first dataset, based on the comparison result of the first dataset and the second dataset. For example, the data that are insufficient in the second dataset relative to the first dataset, are added to the second dataset. Alternatively, the data that are excessive in the second dataset relative to the first dataset, are deleted from the second dataset.

The corrected second dataset is inputted to the learning unit 180 as training data. In addition, the 3D face image corresponding to the 2D face images included in the second dataset is also inputted to the learning unit 180 as training data. The 2D face images and the 3D face image may be inputted to the learning unit 180 in association with each other. For example, the 2D face images and the 3D face images corresponding to the 2D face images may be inputted to the learning unit 180, in a state in which it is clear that they are face images of the same person. The learning unit 180 performs the learning of the face authentication engine, by using the inputted 2D face images and the inputted 3D face image.

### Technical Effect

Next, a technical effect obtained by the information processing system 10 according to the 12th example embodiment will be described.

As described in FIG. 17 and FIG. 18, in the information processing system 10 according to the 12th example embodiment, the learning of the face authentication engine is performed, by using the second dataset including the 2D face images corrected to be closer to the first dataset, and the 3D face image corresponding to the 2D face images included in the second dataset. In this way, it is possible to properly perform the learning of the face authentication engine that allows authentication, by using both the 2D face images and the 3D face image.

### 13th Example Embodiment

The information processing system 10 according to a 13th example embodiment will be described with reference to FIG. 19. The 13th example embodiment partially differs from the 12th example embodiment only in its configuration and operation, and may be the same as the first to 12th example embodiments in the other parts. For this reason, a part differing from each of the example embodiments described above will be described in detail below, and a description of the other overlapping parts will be omitted as appropriate.

### Functional Configuration

First, with reference to FIG. 19, a functional configuration of the information processing system 10 according to the 13th example embodiment will be described. FIG. 19 is a block diagram illustrating the functional configuration of the information processing system according to the 13th example embodiment. In FIG. 19, the same components as those illustrated in FIG. 17 carry the same reference numerals.

As illustrated in FIG. 19, the information processing system 10 according to the 13th example embodiment includes, as components for realizing the functions thereof, the input unit 110, the extraction unit 120, the output unit 130, the learning unit 180, and an authentication unit 190. That is, the information processing system 10 according to the 13th example embodiment further includes the authentication unit 190, in addition to the configuration in the 12th example embodiment (see FIG. 17). The authentication unit 190 may be a processing block realized by the processor 11 (see FIG. 1), for example.

The authentication unit 190 is configured to perform the face authentication by using the face authentication engine learned/trained by the learning unit 180 described in the 12th example embodiment. Specifically, the authentication unit 190 is configured to perform the face authentication, by collating/verifying a 2D face image acquired from an authentication target with a 3D face image registered in advance, by using the face authentication engine. The 2D face image may be acquired by capturing a face of the authentication target with a camera. The 3D face image may be generated by capturing the face of the authentication target from a plurality of angles with a camera in advance. Since an authentication method using the 2D face image and the 3D face image can adopt existing techniques/technologies as appropriate, a detailed explanation of the method is omitted here.

### Technical Effect

Next, a technical effect obtained by the information processing system 10 according to the 13th example embodiment will be described.

As described in FIG. 19, in the information processing system 10 according to the 13th example embodiment, the face authentication is performed by using the face authentication engine learned/trained by using the 2D face images and the 3D face image. In this way, it is possible to achieve high authentication accuracy in the face authentication in which the 2D face image is collated/verified with the 3D face image.

### 14th Example Embodiment

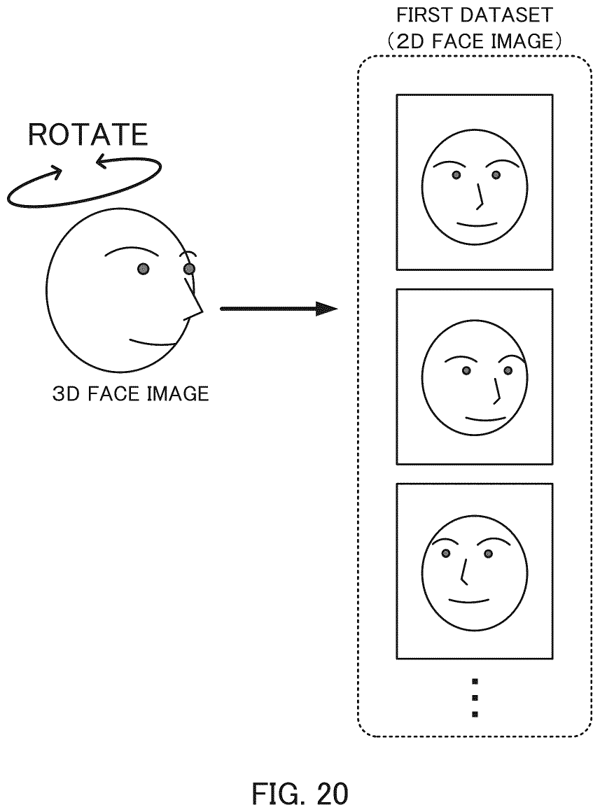

The information processing system 10 according to a 14th example embodiment will be described with reference to FIG. 20. The 14th example embodiment partially differs from the 12th and 13th example embodiments described above only in its operation, and may be the same as those in the first to 13th example embodiments in the other parts. For this reason, a part differing from each of the example embodiments described above will be described in detail below, and a description of the other overlapping parts will be omitted as appropriate.

### First Dataset Generation

First, with reference to FIG. 20, a first dataset generation operation by the information processing system 10 according to the 14th example embodiment will be described. FIG. 20 is a conceptual diagram illustrating an example of generating the first dataset in the information processing system according to the 14th example embodiment.

As illustrated in FIG. 20, in the information processing system 10 according to the 14th example embodiment, a 3D face image is rotated, thereby to generate a plurality of 2D face images with different facing angles. For example, from a single 3D face image, a front-facing face image, a right-facing face image, and a left-facing face image are generated. In the 14th example embodiment, the plurality of 2D face images generated in this manner are used as the first dataset. That is, the first dataset according to the 14th example embodiment includes the plurality of 2D face images with different facing angles.

The first dataset described above is compared with the second dataset including the plurality of 2D face images. Then, the output unit 130 outputs information about the facing angle that is insufficient in the second dataset or the facing angle that is excessive in the second dataset, as the comparison result of the first dataset and the second dataset.

### Technical Effect

Next, a technical effect obtained by the information processing system 10 according to the 14th example embodiment will be described.

As described in FIG. 20, in the information processing system 10 according to the 14th example embodiment, the first dataset includes the plurality of 2D face images (i.e., the 2D images with different facing angles) obtained by rotating the 3D face image. The use of such a first dataset makes it possible to properly grasp the facing angle that is insufficient in the second dataset, or the facing angle that is excessive in the second dataset.

### 15th Example Embodiment

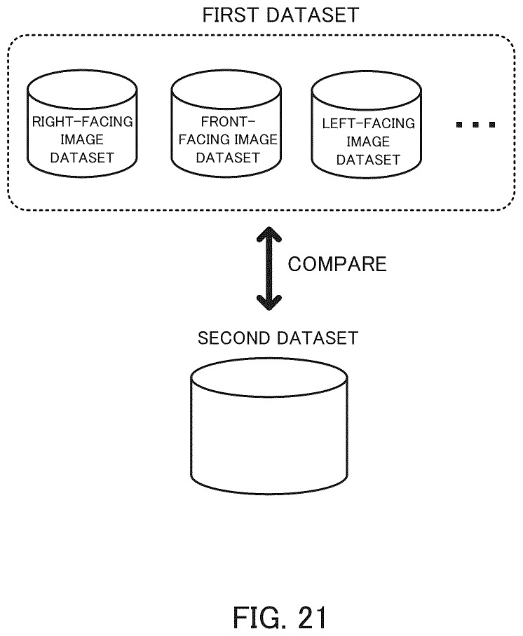

The information processing system 10 according to a 15th example embodiment will be described with reference to FIG. 21. The 15th example embodiment partially differs from the 12th to 14th example embodiments described above only in its operation, and may be the same as those in the first to 14th example embodiments in the other parts. For this reason, a part differing from each of the example embodiments described above will be described in detail below, and a description of the other overlapping parts will be omitted as appropriate.

### Output Example of Guide Information

First, with reference to FIG. 28, a dataset comparison operation by the information processing system 10 according to the 15th example embodiment will be described. FIG. 21 is a conceptual diagram illustrating the comparison operation by the information processing system according to the 15th example embodiment.

As illustrated in FIG. 21, in the information processing system 10 according to the 15th example embodiment, the first dataset includes a plurality of angle-specific datasets with a collection of 2D face images by facing angle. For example, the first dataset includes a right-facing image dataset with a collection of right-facing face images, a front-facing image dataset with a collection of front-facing face images, and a left-facing image dataset with a collection of left-facing face images.

The first dataset described above is compared with the second dataset including the plurality of 2D face images. In this case, the second dataset may be compared sequentially with the angle-specific datasets. For example, processing of comparing the right-facing image dataset with the second dataset, processing of comparing the front-facing image dataset with the second dataset, and processing of comparing the left-facing image dataset with the second dataset may be performed separately.

Then, the output unit 130 outputs information about the facing angle that is insufficient in the second dataset or the facing angle that is excessive in the second dataset, as the comparison result of the first dataset and the second dataset. For example, in a case where the comparison between the right-facing image dataset and the second dataset reveals that there is an insufficient part in the second dataset, the output unit 130 may output a comparison result indicating that the right-facing face images are insufficient in the second dataset. In addition, in a case where the comparison between the left-facing image dataset and the second dataset reveals that there is an excessive part in the second dataset, the output unit 130 may output a comparison result indicating that the left-facing face images are excessive in the second dataset.

### Technical Effect

Next, a technical effect obtained by the information processing system 10 according to the 15th example embodiment will be described.

As described in FIG. 21, in the information processing system 10 according to the 15th example embodiment, the first dataset includes a plurality of angle-specific datasets with a collection of 2D face images by facing angle. The use of such a first dataset makes it possible to properly grasp the facing angle that is insufficient in the second dataset, or the facing angle that is excessive in the second dataset.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of SaaS (Software as a Service), for example.

### SUPPLEMENTARY NOTES

The example embodiments described above may be further described as, but not limited to, the following Supplementary Notes below.

### Supplementary Note 1

An information processing system according to Supplementary Note 1 is an information processing system including: an input unit that inputs a first dataset and a second dataset into a learning model; an extraction unit that extracts an output of intermediate processing of the learning model; and an output unit that outputs a comparison result of the first dataset and the second dataset, in a space in which dimensions of the output of the intermediate processing are compressed.

### Supplementary Note 2

An information processing system according to Supplementary Note 2 is the information processing system according to Supplementary Note 1, wherein the first dataset is a dataset serving as a target upon operating the learning model, and the second dataset is a dataset intended to bring a data distribution closer to that of the first dataset.

### Supplementary Note 3

An information processing system according to Supplementary Note 3 is the information processing system according to Supplementary Note 1 or 2, wherein the output unit compresses the dimensions of the output of the intermediate processing by using at least one of PCA, t-SNE, and UMAP.

### Supplementary Note 4

An information processing system according to Supplementary Note 4 is the information processing system according to Supplementary Note 1 or 2, wherein the output unit compares the first dataset with the second dataset, and extracts and outputs at least one of an insufficient area and an excessive area of the second dataset relative to the first dataset.

### Supplementary Note 5

An information processing system according to Supplementary Note 5 is the information processing system according to Supplementary Note 4, wherein the output unit outputs the comparison result of the first dataset and the second dataset, in an aspect of emphasizing a part corresponding to at least one of the insufficient area and the excessive area.

### Supplementary Note 6

An information processing system according to Supplementary Note 6 is the information processing system according to Supplementary Note 4 or 5, further including a data updating unit that adds data to the second dataset, based on the insufficient area, and deletes data from the second dataset, based on the excessive area.

### Supplementary Note 7

An information processing system according to Supplementary Note 7 is the information processing system according to Supplementary Note 6, wherein the data updating unit acquires a difference in density between the first dataset and the second dataset, and adds or deletes data, preferentially to or from an area in which the difference is large.

### Supplementary Note 8

An information processing system according to Supplementary Note 8 is the information processing system according to any one of Supplementary Notes 1 to 7, further including a first display unit that displays the comparison result of the first dataset and the second dataset as a plurality of objects, and that displays content of data corresponding to an object selected from among the plurality of objects.

### Supplementary Note 9

An information processing system according to Supplementary Note 9 is the information processing system according to any one of Supplementary Notes 1 to 8, further including a second display unit that displays the comparison result of the first dataset and the second dataset in an aspect that allows area selection, and that graphically displays a ratio of data included in the selected areas, by attribute.

### Supplementary Note 10

An information processing system according to Supplementary Note 10 is the information processing system according to any one of Supplementary Notes 1 to 9, wherein the input unit inputs a third dataset into the learning model, in addition to the first dataset and the second dataset, the output unit outputs a comparison result of the first dataset, the second dataset, and the third dataset, in a space in which dimensions of the output of the intermediate processing are compressed, and the information processing system further includes an adjustment unit that performs adjustment of compensating for an excessive or insufficient part of each of the first dataset, the second dataset, and the third dataset, based on the comparison result.

### Supplementary Note 11

An information processing system according to Supplementary Note 11 is the information processing system according to Supplementary Note 10, wherein the output unit compares the third dataset with a result of integrating the first dataset and the second dataset, thereby to output an excessive or insufficient part of the third dataset respective to the first dataset and the second dataset.

### Supplementary Note 12

An information processing system according to Supplementary Note 12 is the information processing system according to any one of Supplementary Notes 2 to 11, wherein each of the first dataset and the second dataset is a dataset including a 2D face image, and the information processing system further includes a learning unit that performs learning of a face authentication engine used for face authentication, by using the second dataset corrected to be closer to the first dataset based on the comparison result, and a 3D face image of a person corresponding to the 2D face image included in the second dataset.

### Supplementary Note 13

An information processing system according to Supplementary Note 13 is the information processing system according to Supplementary Note 12, further including an authentication unit that performs face authentication, by collating/verifying a 2D face image acquired from an authentication target with a 3D face image registered in advance, by using the face authentication engine leaned/trained by the learning unit.

### Supplementary Note 14

An information processing system according to Supplementary Note 14 is the information processing system according to Supplementary Note 12 or 13, wherein the first dataset includes a plurality of 2D face images with different facing angles obtained by rotating a 3D face image, and the output unit outputs a facing angle that is an excessive or insufficient part of the second dataset relative to the first dataset, by comparing the first dataset and the second dataset.

### Supplementary Note 15

An information processing system according to Supplementary Note 15 is the information processing system according to Supplementary Note 12 or 13, wherein the first dataset includes a plurality of angle-specific datasets that is a collection of 2D face images by facing angle, and the output unit outputs a facing angle that is an excessive or insufficient part of the second dataset relative to the first dataset, by comparing the first dataset and the second dataset.

### Supplementary Note 16

An information processing method according to Supplementary Note 16 is an information processing method that is executed by at least one computer, the information processing method including: inputting a first dataset and a second dataset into a learning model; extracting an output of intermediate processing of the learning model; and outputting a comparison result of the first dataset and the second dataset, in a space in which dimensions of the output of the intermediate processing are compressed.

### Supplementary Note 17

A recording medium according to Supplementary Note 17 is a recording medium on which a computer program that allows at least one computer to execute an information processing method is recorded, the information processing method including: inputting a first dataset and a second dataset into a learning model; extracting an output of intermediate processing of the learning model; and outputting a comparison result of the first dataset and the second dataset, in a space in which dimensions of the output of the intermediate processing are compressed.

### Supplementary Note 18

A computer program according to Supplementary Note 18 is a computer program that allows at least one computer to execute an information processing method, the information processing method including: inputting a first dataset and a second dataset into a learning model; extracting an output of intermediate processing of the learning model; and outputting a comparison result of the first dataset and the second dataset, in a space in which dimensions of the output of the intermediate processing are compressed.

The present disclosure is allowed to be changed, if desired, without departing from the essence or spirit of this disclosure which can be read from the claims and the entire specification. An information processing system, an information processing method, and a recording medium with such changes are also intended to be within the technical scope of the present disclosure.

### DESCRIPTION OF REFERENCE CODES

10 Information processing system
11 Processor
110 Input unit
120 Extraction unit
130 Output unit
140 Updating unit
150 First display unit
160 Second display unit
170 Adjustment unit
180 Learning unit

What is claimed is:

1. An information processing system comprising:
at least one memory that is configured to store instructions; and
at least one processor that is configured to execute the instructions to:
input a first dataset and a second dataset into a learning model;
extract an output of intermediate processing of the learning model; and
output a comparison result of the first dataset and the second dataset, in a space in which dimensions of the output of the intermediate processing are compressed.

2. The information processing system according to claim 1, wherein
the first dataset is a dataset serving as a target upon operating the learning model, and
the second dataset is a dataset intended to bring a data distribution closer to that of the first dataset.

3. The information processing system according to claim 1, wherein the at least one processor is configured to execute the instructions to compress the dimensions of the output of the intermediate processing by using at least one of PCA, t-SNE, and UMAP.

4. The information processing system according to claim 1, wherein the at least one processor is configured to execute the instructions to compare the first dataset with the second dataset, and extract and output at least one of an insufficient area and an excessive area of the second dataset relative to the first dataset.

5. The information processing system according to claim 4, wherein the at least one processor is configured to execute the instructions to output the comparison result of the first dataset and the second dataset, in an aspect of emphasizing a part corresponding to at least one of the insufficient area and the excessive area.

6. The information processing system according to claim 4, wherein the at least one processor is configured to execute the instructions to:
add data to the second dataset, based on the insufficient area, and
delete data from the second dataset, based on the excessive area.

7. The information processing system according to claim 6, wherein the at least one processor is configured to execute the instructions to:
acquire a difference in density between the first dataset and the second dataset, and
add or delete data, preferentially to or from an area in which the difference is large.

8. The information processing system according to claim 1, wherein the at least one processor is configured to execute the instructions to:
display the comparison result of the first dataset and the second dataset as a plurality of objects, and
display content of data corresponding to an object selected from among the plurality of objects.

9. The information processing system according to claim 1, wherein the at least one processor is configured to execute the instructions to:
display the comparison result of the first dataset and the second dataset in an aspect that allows area selection, and
graphically display a ratio of data included in the selected areas, by attribute.

10. The information processing system according to claim 1, wherein the at least one processor is configured to execute the instructions to:
input a third dataset into the learning model, in addition to the first dataset and the second dataset,
output a comparison result of the first dataset, the second dataset, and the third dataset, in a space in which dimensions of the output of the intermediate processing are compressed, and
perform adjustment of compensating for an excessive or insufficient part of each of the first dataset, the second dataset, and the third dataset, based on the comparison result.

11. The information processing system according to claim 10, wherein the at least one processor is configured to execute the instructions to compare the third dataset with a result of integrating the first dataset and the second dataset, thereby to output an excessive or insufficient part of the third dataset respective to the first dataset and the second dataset.

12. The information processing system according to claim 2, wherein
each of the first dataset and the second dataset is a dataset including a 2D face image, and
the at least one processor is configured to execute the instructions to perform learning of a face authentication engine used for face authentication, by using the second dataset corrected to be closer to the first dataset based on the comparison result, and a 3D face image of a person corresponding to the 2D face image included in the second dataset.

13. The information processing system according to claim 12, wherein the at least one processor is configured to execute the instructions to perform face authentication, by collating/verifying a 2D face image acquired from an authentication target with a 3D face image registered in advance, by using the face authentication engine leaned/trained-by

14. The information processing system according to claim 12, wherein
the first dataset includes a plurality of 2D face images with different facing angles obtained by rotating a 3D face image, and
the at least one processor is configured to execute the instructions to output a facing angle that is an excessive or insufficient part of the second dataset relative to the first dataset, by comparing the first dataset and the second dataset.

15. The information processing system according to claim 12, wherein
the first dataset includes a plurality of angle-specific datasets that is a collection of 2D face images by facing angle, and
the at least one processor is configured to execute the instructions to output a facing angle that is an excessive or insufficient part of the second dataset relative to the first dataset, by comparing the first dataset and the second dataset.

16. An information processing method that is executed by at least one computer, the information processing method comprising:
inputting a first dataset and a second dataset into a learning model;
extracting an output of intermediate processing of the learning model; and
outputting a comparison result of the first dataset and the second dataset, in a space in which dimensions of the output of the intermediate processing are compressed.

17. A non-transitory recording medium on which a computer program that allows at least one computer to execute an information processing method is recorded, the information processing method including:
inputting a first dataset and a second dataset into a learning model;
extracting an output of intermediate processing of the learning model; and
outputting a comparison result of the first dataset and the second dataset, in a space in which dimensions of the output of the intermediate processing are compressed.
